(19) United States
(12) Patent Application Publication
(10) Pub. No.: US 2008/0010156 A1
(43) Pub. Date: Jan. 10, 2008

(54) Local Exchange of Items and Services

(75) Inventor: Jonathan P. Coudron, Hopkins, MN (US)

Correspondence Address: MERCHANT & GOULD PC, P.O. BOX 2903, MINNEAPOLIS, MN, 55402-0903, US

(73) Assignee: LIQUID CONCEPTS, LLC, Hopkins, MN (US)

(21) Appl. No.: 11/765,561

(22) Filed: Jun. 20, 2007

Related U.S. Application Data
(60) Provisional application No. 60/805,330, filed on Jun. 20, 2006.

(51) Int. Cl. G06Q 30/00

(52) U.S. Cl. 705/14

(57) ABSTRACT

An exchange platform facilitates the transaction of goods and/or services in a local area. The exchange platform allows sellers to create sale postings for goods or services, and potential buyers to review the sale postings. Once transaction fees are paid, contact information is provided so that the buyer and seller can meet to exchange the goods or services for payment. The transaction fees can be paid using credits that are earned by viewing sponsor advertisements.

### RELATED APPLICATION

This application claims the benefit of U.S. patent application Ser. No. 60/805,330 filed on Jun. 20, 2006, the entirety of which is hereby incorporated by reference.

### BACKGROUND

The Internet is a worldwide system of connected computer networks. The Internet enables computers of all kinds to communicate directly, as if the computers were part of one giant, seamless global computing machine. The Internet is currently configured to join together large commercial communications services, as well as thousands of university, government, and corporate computer networks and other computers. The World Wide Web is a collection of web pages and web sites that are accessible via the Internet by means of various communication protocols (e.g., HTTP, FTP). Communication over the World Wide Web can be interactive, and is sometimes referred to as being “online.”

Currently, there are online systems that allow users to post items for sale. Certain web sites provide sellers with access to buyers who will pay a fair market value for items through an “online auction system.” Part of the success of online auction systems is the ability of sellers to reach a large number of potential bidders. One of the problems associated with online auction systems is that potential participants may be wary of the real or perceived risks associated with buying and selling items online. These range from buyers' fears that a seller might not ship an item once payment is received, to buyers' fears that they are buying an item with out the benefit of inspection or the risks associated with an attempted return. Further, there are additional shipping costs and delays associated with returned items.

In one example, although campus bookstores provide a service to students who seek to exchange or sell textbooks, there are little, if any, services available to college students to exchange other educational resources within a campus. One of the inherent problems with the sale and exchange system currently in operation at universities is that the money received by a student on the sale or exchange of a book is often substantially less than the amount originally required to purchase the book.

One alternative to using campus bookstores is for students to use online companies to sell used books, such as the online auction sites described above. These systems, like other online systems, often involve problems such as lengthy shipping times and costs, as well as buyers receiving “beat-up” or incorrect editions. Further, under the existing system, students are still left with solutions only for books and not other resource materials, such as notes, quizzes, exams, entertainment items, and furniture.

### SUMMARY

The present disclosure relates to an exchange platform that facilitates the transaction of goods and/or services in a local area. In example embodiments, the exchange platform allows sellers to create sale postings for goods or services, and potential buyers to review the sale postings. Once transaction fees are paid, contact information is provided so that the buyer and seller can meet to exchange the goods or services for payment. In some examples, the transaction fees can be paid using credits that are earned by viewing sponsor advertisements.

### DESCRIPTION OF THE DRAWINGS

Reference is now made to the accompanying drawings, which are not necessarily drawn to scale.

FIG. 1 shows an example exchange environment including an exchange platform that is accessible by a plurality of users over a network.

FIG. 2 shows an example of one of the local areas of the exchange environment of FIG. 1.

FIG. 3 shows an example method for facilitating the exchange of goods or services in a local area using the exchange platform of FIG. 1.

FIG. 4 shows an example transaction processes using the exchange platform of FIG. 1.

FIG. 5 shows a logical portion of the example exchange platform of FIG. 1.

FIG. 6 shows an example user interface of the exchange platform of FIG. 5.

FIG. 7 shows another example user interface of the exchange platform of FIG. 5.

FIG. 8 shows another example user interface of the exchange platform of FIG. 5.

FIG. 9 shows an example method for earning credits using the exchange platform of FIG. 1.

### DETAILED DESCRIPTION

Example embodiments will now be described more fully hereinafter with reference to the accompanying drawings. These embodiments are provided so that this disclosure will be thorough and complete. Like numbers refer to like elements throughout.

The present disclosure relates to an exchange platform that facilitates the transaction of goods and/or services in a local area. In example embodiments, the exchange platform allows sellers to create sale postings for goods or services, and potential buyers to review the sale postings. Once transaction fees are paid, contact information is provided so that the buyer and seller can meet to exchange the goods or services for payment. In some examples, the transaction fees can be paid using credits that are earned by viewing sponsor advertisements.

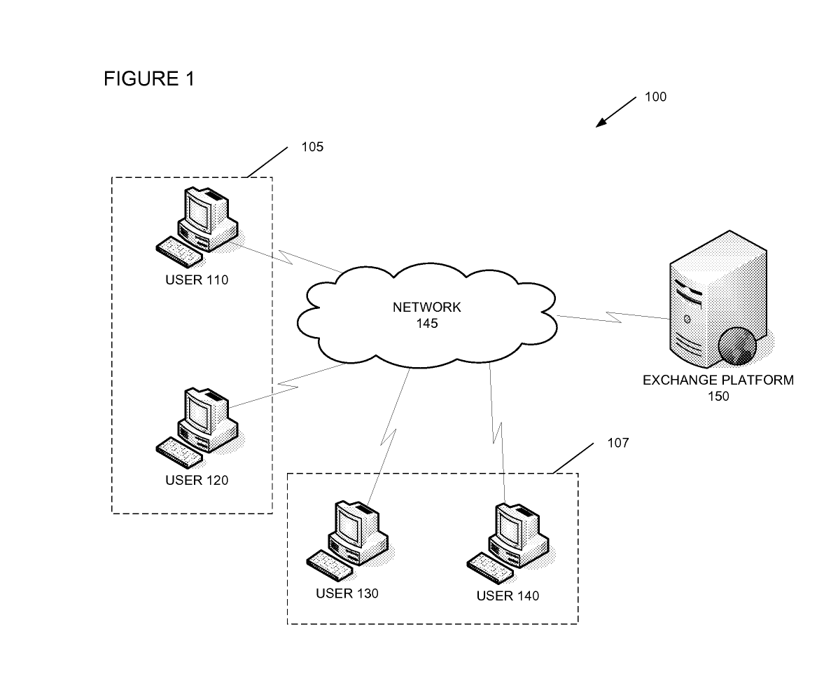

Referring now to FIG. 1, an example exchange environment 100 is shown. The exchange environment 100 includes users 110, 120, 130, and 140, and an exchange platform 150. The users 110, 120, 130, and 140 utilize computers to access the exchange platform 150 through a network 145, such as the Internet. Although only four users are shown in the example, a plurality of users can access the exchange platform 150.

In the example shown, the users 110, 120 are located at or near a local area 105, and the users 130, 140 are located at or near a local area 107. Examples of local areas including a school campus (e.g., high school or college campus), a neighborhood, a city, a county, a state, or some other area that defines a proximity in which two people can readily travel to meet one another. In one example described herein, the users 110, 120 are located on a first college campus or attend the college located on the first college campus, and the users 130, 140 are similarly located on a second college campus or attend the college located on the second college campus.

In examples described herein, the exchange platform 150 is a computer system, such as a server, including a processing unit and computer readable media. Computer readable media can include memory such as volatile (such as RAM), non-volatile (such as ROM, flash memory, etc.) or some combination thereof. Additionally, the exchange platform 150 includes mass storage (removable and/or non-removable) such as a magnetic or optical disks or tape. An operating system, such as Linux or Windows, and one or more application programs can be stored on the mass storage device. The exchange platform 150 includes input devices (such as a keyboard and mouse) and output devices (such as a display and printer). The exchange platform 150 also includes network connections to other devices, computers, networks, servers, etc.

In example embodiments, the target users 110, 120, 130, 140 can communicate with the exchange platform 150 through the network 145. In example embodiments, the network 145 is a local area network (LAN), a wide area network (WAN), the Internet, or a combination thereof. Communications between the target users 110, 120, 130, 140, the network 145, and the exchange platform 150 can be implemented using wired and/or wireless technologies.

In example embodiments, the exchange platform 150 includes one or more web servers that host one or more web sites that are accessible from the network 145. The exchange platform 150 can include one or more data stores such as, for example, one or more databases.

In the embodiments disclosed herein, the target users 110, 120, 130, 140 can access a web site hosted by the exchange platform 150 using one or more computers. For example, each of the target users 110, 120, 130, 140 can use a web browser application on a computer to access the exchange platform 150 over known protocols such as hypertext markup language (“HTML”) and/or extensible markup language (“XML”). One example of a browser application is the Internet Explorer browser offered by Microsoft Corporation. Other types of browsers and configurations are possible.

In some embodiments, the exchange platform 150 includes separate web sites for each local area, such as the local areas 105, 107. When the users 110, 120, 130, 140 access the exchange platform 150, the users 110, 120, 130, 140 can select the desired local area to browse sale postings on a web site that is specific to the selected local area. In one example, a different domain name or Uniform Resource Locator (“URL”) is provided for each site for each local area. In yet another example, a central domain name is used, and each site for each local area is a sub-domain of the central domain name. Other examples are possible.

### I. Exchange in Local Area

In example embodiments described herein, the user 110 is a seller of a good or service, and the user 120 is the potential buyer of that good or service. As described further below, the user 110 can access the web site associated with the local area 105 on the exchange platform 150 to place a sale posting to sell a good or service. The user 120 can likewise access the web site on the exchange platform 150 to browse the sale postings to potentially purchase a good or service. If the user 120 desires to purchase the good or service from the user 110, the exchange platform 150 facilitates the face-to-face meeting of the user 110 and the user 120 to complete the transaction within or in the general proximity of the local area 105, as described further below.

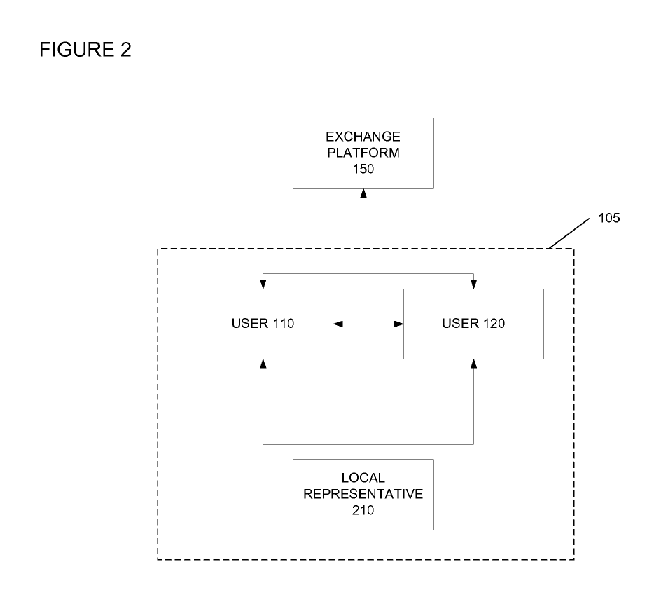

Referring now to FIG. 2, the local area 105 of the exchange environment 100 is shown. The local area 105 also includes a local representative 210.

The local representative 210 is located at or in close proximity to the local area 105. In example embodiments, the local representative 210 helps to manage the exchange platform 150. This management can include the promotion of the exchange platform 150 to add to the user base. For example, the local representative 210 can conduct targeted marketing specific to the local area 105 (e.g., flyers, posters, direct mailings, local radio/television/newspaper advertisements, sidewalk chalking, special promotional events etc.) and provide incentives to new users, such as free credits, to entice users to sign-up, access, and use the exchange platform 150.

In one example, the local representative 210 can leverage organizations located in the local area 105 to assist in the marketing efforts. For example, the local representative 210 can employ members of an organization located in the local area (e.g., a student organization on a college campus) to help distribute flyers or otherwise advertise. The organizations can be compensated for the work in the form of flat or commissioned payments. For example, the organization can be compensated by sharing a portion of the commission that is paid to the local representative 210, as described below.

In example embodiments, the local representative 210 is an individual that is familiar with the local area 105 that can devote marketing efforts on a part-time basis. Examples of such individuals include stay-at-home parents, professional product representative personnel, and local marketing firm personnel. Although a single local representative 210 is shown, in other examples, multiple local representatives can be provided for each local area.

In some examples, the local representative 210 also performs other functions. For example, the local representative 210 can answer questions from new or existing users (e.g., by email, telephone, or in person), or otherwise provide local customer service to users.

In example embodiments, the local representative 210 is compensated on a commission basis. For example, commissions can be based on a per transaction basis (e.g., $0.75 per transaction) with respect to each transaction fee that is paid by users of the exchange platform 150, as described below. In other embodiments, other forms of compensation can be used, such as a flat or per-hour salary.

In other examples, the local representative 210 can function as a “virtual” franchisee of the exchange platform 150. The local representative 210 can pay fees in exchange for franchise rights in one or more local areas. For example, the local representative 210 can pay fees to set up a franchise on a particular college campus. Other configurations are possible.

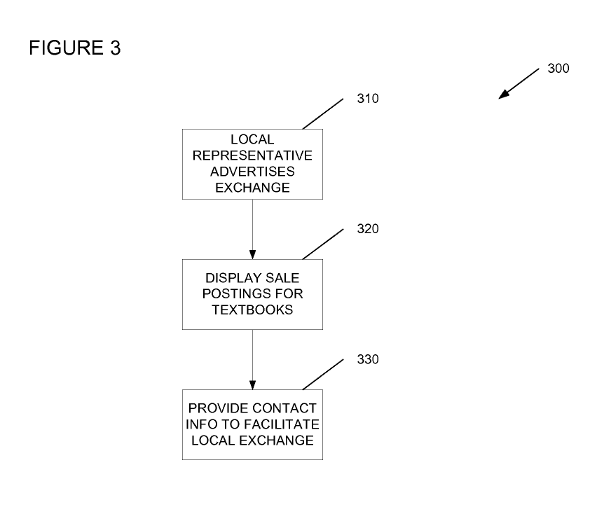

Referring now to FIG. 3, an example method 300 is shown. The method 300 illustrates an example process for facilitating the exchange of goods or services in a local area. In the example shown, the method 300 relates to the exchange of textbooks on a college campus, although other goods and services can be used, as described below.

At operation 310, the local representative advertises the exchange platform to potential and existing users on the college campus to increase the use of the exchange platform. Typically, such potential users are students and faculty that need textbooks for various classes on the campus. As described above, such advertising can take various forms and involve other organizations as well.

Next, at operation 320, sale postings provided by users located on the campus are displayed on the web site specific for the college campus on the exchange platform. Potential buyers can review these sale postings to find textbooks that the buyers may want to buy. For example, potential buyers, such as students, can review the sale postings to locate textbooks for upcoming classes taught on the campus.

Next, at operation 330, the contact information is provided for a particular buyer or seller to facilitate the local exchange of the textbook for payments. For example, as described further below, the sale posting can include the seller's contact information, so that the potential buyer can contact the seller to set up a time to meet on or near the college campus. The potential buyer and seller can then meet at the selected time so that the potential buyer can review the textbook before purchase. The potential buyer can then directly pay the seller should the potential buyer want to purchase the textbook.

### II. Transaction Process

The seller must register for an account on the exchange platform before he or she can create a sale posting to sell a good or service. Registration requires the seller to provide bibliographic information (e.g., name, telephone number, and email address), as well as to select a username and password. Other optional information can also be collected, such as gender, school attended, grade level, if the individual lives on or off campus, major, marital status, and/or birthday. Once registered, an account is created on the exchange platform for the seller.

To create the sale posting, the seller initially selects the category of the item to be sold. In one example, the item is a textbook, although other items can be sold as well, as described below. In addition, in some examples the user may also be required to select sub-categories to further refine the type of item for sale. For example, the user is required to select a category for the textbook such as accounting, mathematics, physics, astronomy, etc.

The seller then provides information specific to the textbook to be sold. This information can include: ISBN; title; author(s); and edition. In one example, if the seller provides the ISBN, the exchange platform can be programmed to lookup and populate the other information about the book, including title, author, and edition. The seller can also provide other information such as: a description of the textbook; a picture of the textbook (e.g., in GIF, JPEG, or PNG formats); a condition of the text (e.g., Poor, Okay, Good, Very Good, and Excellent, or a scale of condition from 1-5 stars); and a price. The seller can also provide other information, such as an expiration date for the sale posting (e.g., one week or one month).

After providing the information about the textbook, the seller is prompted regarding whether or not the seller wishes to pay a transaction fee to allow the seller's contact information to be provided in conjunction with the sale posting. If the seller pays the transaction fee (using purchased or earned credits, as described further below) the seller's contact information is provided in conjunction with the sale posting, so that potential buyers can contact the seller, as described above, to schedule a personal meeting in or near the local area to review and possibly buy the textbook. If, however, the seller elects not to pay the transaction fee at this time, the sale posting is shown on the exchange platform without the seller's contact information. A potential buyer interested in purchasing the textbook can thereupon purchase the seller's contact information or express interest in the sale posting, as described further below.

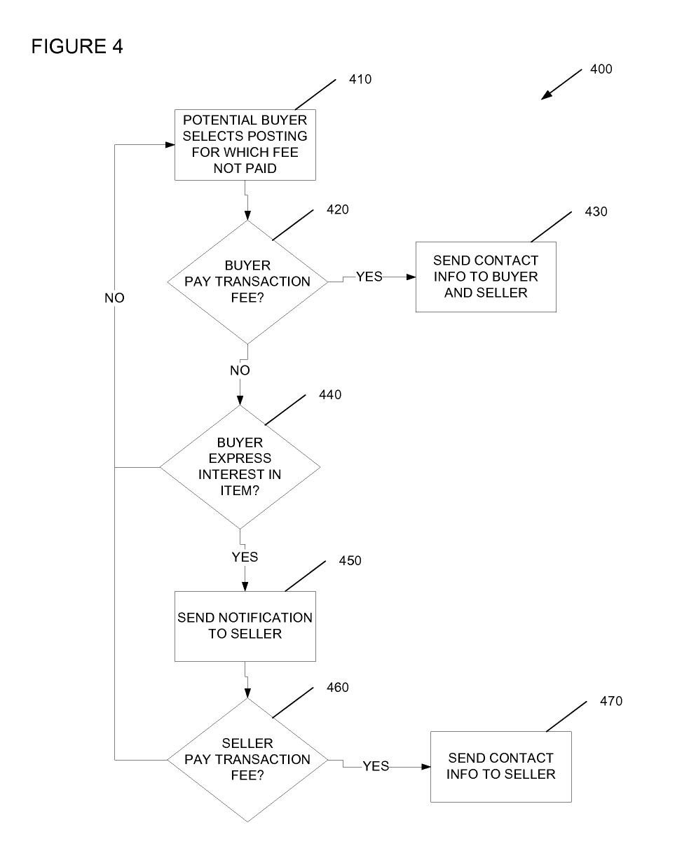

Referring now to FIG. 4, an example method 400 is shown. The method 400 generally illustrates the transaction processes in which a buyer creates a sale posting on the exchange platform and elects not to pay the transaction fee upfront.

At operation 410, the potential buyer selects a sale posting for a desired textbook for which the transaction fee has not been paid upfront by the seller. Before the potential buyer can pay the transaction fee or express an interest, the potential buyer must have an account on the exchange platform. To create an account, the potential buyer must provide bibliographic information (e.g., name, telephone number, and email address), as well as select a username and password. Once registered, an account is created on the exchange platform for the potential buyer.

Next, at operation 420, the potential buyer is prompted by the exchange platform regarding whether or not the user wants to pay the transaction fee to purchase the seller's contact information. If the potential buyer pays the transaction fee (using purchased or earned credits), control is passed to operation 430, at which the seller's information is provided to the buyer, and the buyer's information is provided to the seller (e.g., the exchange platform can generate an email to the seller including the potential buyer's contact information). The potential buyer and seller can then schedule a personal meeting in or near the local area to review and possibly buy the textbook.

If the potential buyer instead decides not to pay the transaction fee at operation 420, control is passed to operation 440. If the potential buyer elects to express an interest in the textbook, control is passed to operation 450, at which a notification (e.g., email, telephone call, text message, etc.) is sent to the seller stating that a potential buyer has expressed an interest in the textbook.

Next, at operation 460, the seller is given the option to pay the transaction fee to purchase the potential buyer's contact information. If the seller decides to pay the transaction fee (using purchased or earned credits), control is passed to operation 470, and the potential buyer's contact information is provided to the seller. The seller can then schedule a personal meeting with the potential buyer in or near the local area to review and possibly sell the textbook.

In example embodiments, the potential buyer or seller can purchase credits to pay the transaction fee. Credits can be purchased using a standard form of payment on the Internet such as, for example, a credit card or a PayPal account. A small fee (e.g., $0.25) can be assessed for each credit purchased, and volume discounts can be provided if multiple credits are purchased. Users can also earn credits, as described further below.

In one example, the transaction fee is 3 credits, which costs between $2.50-$3.25 if purchased, although other amounts can be used. In some embodiments, the transaction fee varies depending on the type of good or service being sold, while in other examples, the transaction fee is uniform. In other embodiments, the potential buyer or seller can pay the transaction fee using credits earned during the buyer's or potential seller's interaction with the exchange platform. For example, as described further below, a user can earn credits by viewing advertisements from sponsors on the exchange platform. The credits are stored in the user's account, and the user can use the credits to pay the transaction fee.

Although the example above is described in the context of the seller creating a sale posting, in alternative embodiments, a potential buyer can create a wanted posting as well. For example, the potential buyer can post a wanted posting for a particular textbook that the potential buyer wants to buy. In addition, the potential buyer can pay the transaction fee upfront, so that the potential buyer's contact information is provided with the wanted posting, or decide not to pay the transaction fee. If the potential buyer does not pay the upfront transaction fee, a seller can decide to pay the transaction fee to obtain the potential buyer's contact information, or to send a notification to the potential buyer after viewing the wanted posting. If a notification is sent, the potential buyer can then decide whether or not to pay the transaction fee to obtain the contact information for the seller.

In some examples, once the transaction fee is paid by the buyer for a sale posting, the seller's contact information is associated with the sale posting on the exchange platform so that other users can access the contact information until the sale posting expires or is otherwise removed from the exchange platform. Likewise, if a seller pays the transaction fee for a wanted posting, the contact information for the buyer is associated with the wanted posting so that other users can access the contact information.

Although the examples provided above are described in the context of the sale of a textbook, other goods can also be sold using the exchange platform. Examples of other types of goods within the college campus context include old college examinations, college notes, entertainment items (e.g., CDs, stereos, guitars, games, automobiles, etc.), and furniture. In addition to goods, services such as tutoring can also be sold.

### III. Earn Credits

One form of payment that potential buyers and sellers can use to pay transaction fees is earned credits. As previously noted, a user can earn credits by viewing advertisements from sponsors on the exchange platform. The credits are stored in the user's account, and the user can use the credits to pay transaction fees.

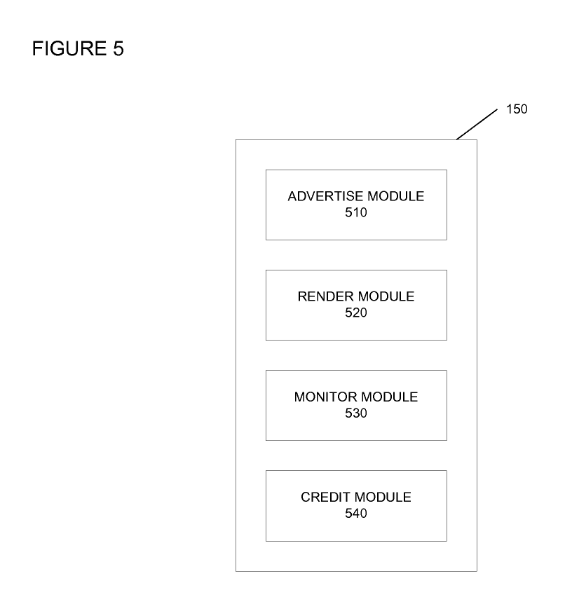

Referring now to FIG. 5, a plurality of logical modules of the exchange platform 150 is shown. Generally, the exchange platform 150 includes an advertise module 510, a render module 520, a monitor module 530, and a credit module 540.

The advertise module 510 is programmed to accept advertising content from a plurality of sponsor advertisers. In example embodiments, the sponsor advertisers are companies that wish to advertise products or services to the users of the exchange platform 150. The advertising content can be in a variety of formats, including static page advertising, as well as audio/video advertising. In one example, the advertising is configured to fill a substantial portion of the user's display, as described below.

The render module 520 is programmed to deliver the advertising content to an end user's computer such that the advertising content is displayed on the end user's computer for a period of time. In example embodiments, the render module 520 is programmed to deliver the content within a browser running on the user's computer, although other delivery methods, such as a standalone client, can be used. In one example, the render module 520 is programmed to deliver the advertising such that the advertising takes up a substantial portion of the user's display.

The monitor module 530 is programmed to calculate earned credits based on the end user's interaction with the advertising content delivered to the end user's computer. For example, the user can earn credits by viewing advertising content for a specific amount of time. The monitor module 530 is programmed to calculate the number of earned credits based on the number of advertisements and/or amount of time the user has viewed the advertising content. In some embodiments, the user is required to periodically interact with the displayed advertisements. In such embodiments, the monitor module 530 is further programmed to monitor the user's interactions to assure that the user has successfully completed the viewing of the advertising content before credits are earned.

The credit module 540 is programmed to maintain a total value of the earned credits and to write the total value to an account of the end user stored on a storage medium of the computer system. In example embodiments, the user can access the user's total number of earned credits stored by the credit module 540. The credit module 540 can be further programmed to subtract earned credits as the user utilizes the credits to pay one or more transaction fees.

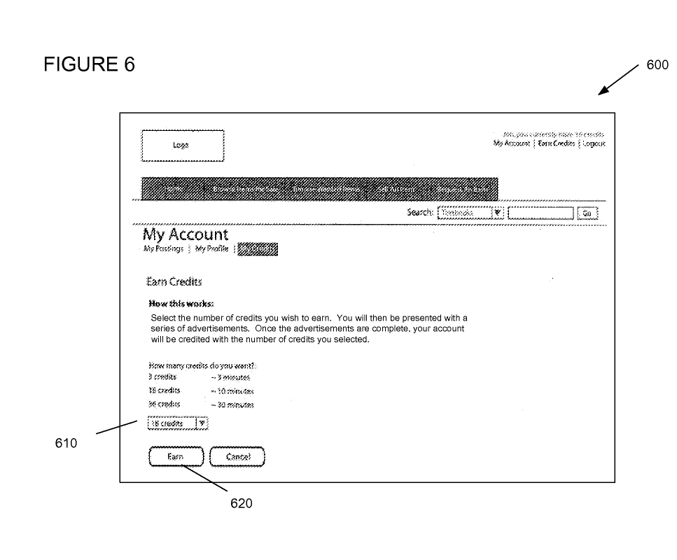

Referring now to FIG. 6, an example user interface 600 is shown. The user interface 600 is generated by the exchange platform and is presented to the user on the user's computer display. In one example, the user interface 600 is provided as a web page that is displayed in the browser running on the user's computer, although other configurations are possible.

In the example shown, the user interface 600 provides information that allows the user to earn credits on the exchange platform. The user interface 600 includes a dropdown menu 610 that allows the user to select the number of credits the user desires to earn. In the embodiment shown, the user can select from 3, 18, and 36 credits. The amount of credits earned depends on the amount of time the user spends viewing the advertising content. For example, the user must spend approximately 3 minutes viewing advertising content to earn 3 credits, approximately 10 minutes for 18 credits, and approximately 30 minutes for 36 credits. Other values can be used. Once the user selects a desired number of credits to be earned from the dropdown menu 610, the user can then select button 620 to being the earning process.

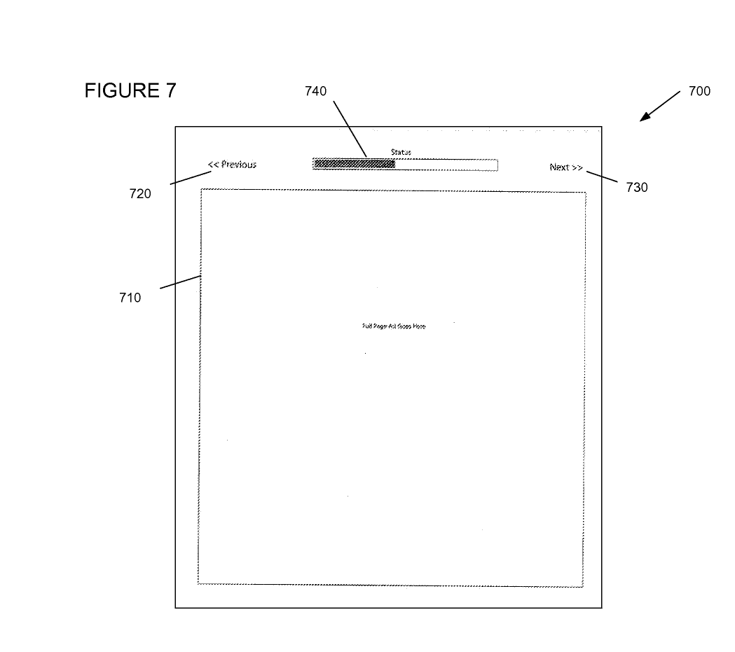

Once the user selects button 620, the user is presented with an example user interface 700, as shown in FIG. 7. The user interface 700 includes a window 710 in which the advertising content (e.g., static pages and/or video) is shown. In some embodiments, the window 710 takes up a substantial portion of the user's display. For example, the window 710 can take up 70-95 percent of the user's display.

The user interface 700 also includes navigation buttons 720, 730 that allow the user to move between the next and previous advertisements. In some embodiments, the navigation buttons 720, 730 are disabled for a certain period of time as each new advertisement is presented to the user in window 710. This forces the advertisement to be presented to the user for at least a threshold amount of time before the user can move to the next or previous advertisement. In some examples, the period of time is set at least 2, 3, 4, 5, 10, or 30 seconds, although other values can be used.

In some examples, the position of the navigation buttons 720, 730 within the user interface 700 are varied over time so that the user is forced to focus on the advertisements as the user moves through advertisements to earn the credits. In yet other embodiments, other forms of user interaction are also required to again force the user to focus on the advertisements. For example, in one embodiment, the user can be periodically required to answer questions during viewing of the advertisements to continue the credit earning process.

The user interface 700 also includes a status indicator 740 that provides the user with an indication of how much of the process the user has completed with respect to earning the desired credits. In the example shown, the status indicator 740 is a bar-graph style indicator with a bar that fills from left to right. As the bar grows, this provides an indication to the user as to how many advertisements are left to view. When the bar fills the entire status indicator 740, the user knows that the required number of advertisements has been viewed.

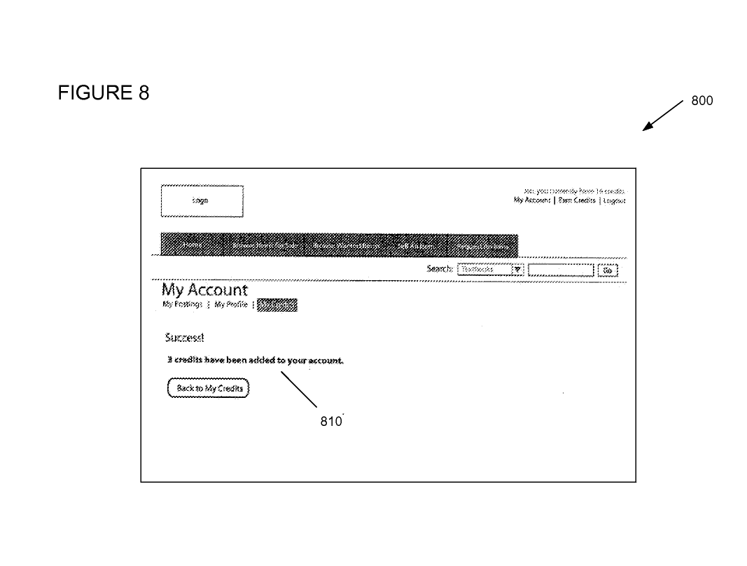

Referring now to FIG. 8, an example user interface 800 is shown that is presented to the user once the user successfully views the required number of advertisements. The user interface 800 provides the user with an indication 810 of the number of earned credits that have been added to the user's account. If the user fails to successfully view the required number of advertisements, another interface can be provided that indicates to the user that the required number of advertisements were not viewed, and provides instructions to allow the user to continue viewing to complete the required number of advertisements.

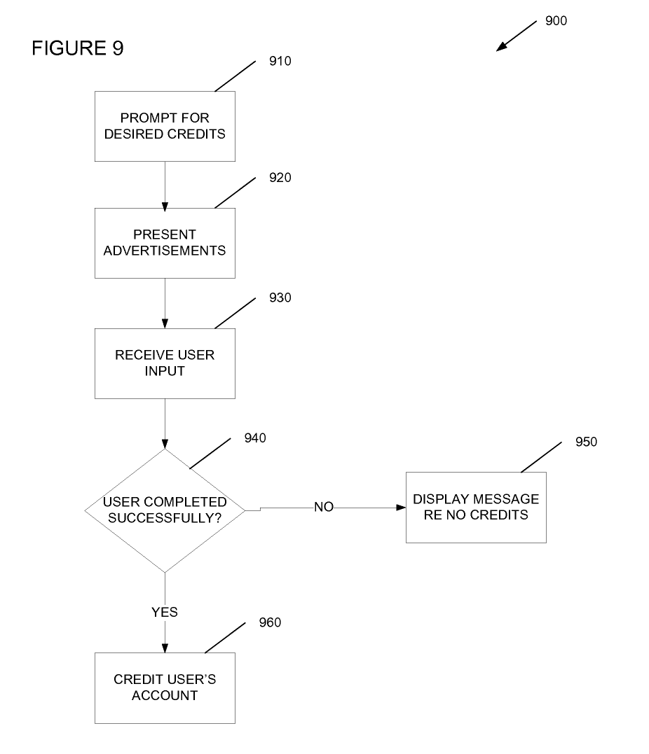

Referring now to FIG. 9, an example method 900 is shown. The method 900 is a process whereby the user can earn credits.

Initially, at operation 910 of the method 900, the user is prompted for the number of credits the user wishes to earn. See, e.g., user interface 600. Next, at operation 920, advertisements are presented to the user, and user input is received at operation 930. See, e.g., user interface 700.

Next, at operation 940, it is determined whether or not the user has successfully completed viewing of the advertisements. If the user has successfully completed viewing of the advertisements, control is passed to operation 960, and the user's account is credited. See, e.g., user interface 800. If a determination is made at operation 940 that the user did not successfully complete viewing of the advertisements, control is instead passed to operation 950, and an indication is provided to the user of the unsuccessful completion, and the user's account is not credited.

In some embodiments, the advertisers that provide advertising content do not pay upfront to have the advertising presented to the users who wish to earn credits. Instead, the advertisers pay after the advertising has been presented to the users. For example, the advertisers pay a flat fee for each advertisement that is presented to the user. In other examples, the fee can vary depending on the type of advertisement and/or the length of the advertisement.

In some examples, the exchange platform is further programmed to track each advertisement that is presented to the user as the user earns credits. The exchange platform (e.g., advertising module) stores the following information in a record for each advertisement that is presented to a user: advertisement ID (i.e., an indicator such as a number that uniquely identifies a particular advertisement); user name of the user to which the advertisement was presented; and a date/time stamp of when the advertisement was presented to the user. These records can be periodically provided to advertisers to show that the advertisements were presented to users so that the advertisers can then pay for the advertisements.

Although the example provided above describes the presentation of advertisements to the user, in other embodiments, the user can also be presented with interactive surveys. For example, the user can be provided with a survey within the window 710 of the user interface 700 that presents the user with a series of questions. These questions can be, for example, tailored by an advertiser to obtain desired information about a certain demographic. Upon completion of one or more surveys, the user can earn credits. Other configurations are possible.

In addition, in some embodiments, the earned credits can be used for more than paying transaction fees. For example, in one alternative embodiment, the earned credits can be used to purchase goods and/or services from retailers in a manner similar to how points earned by using a credit card can be used to purchase goods or services. In some examples, retailers can register with the exchange platform so that the retailers can accept the earned credits in exchange for goods or services.

The various embodiments described above are provided by way of illustration only and should not be construed to limiting. Those skilled in the art will readily recognize various modifications and changes that may be made to the embodiments described above without departing from the true spirit and scope of the disclosure or the following claims.

What is claimed is:

1. A computer system, comprising:
an advertise module programmed to accept advertising content from a plurality of advertisers;
a render module programmed to deliver the advertising content to an end user's computer such that the advertising content is displayed on the end user's computer for a period of time;
a monitor module programmed to calculate earned credits based on the end user's interaction with the advertising content delivered to the end user's computer; and
a credit module programmed to maintain a total value of the earned credits and to write the total value to an account of the end user stored on a storage medium of the computer system.

2. The system of claim 1, wherein the advertise module is further programmed to store a record including an advertisement identification, a user name, and a time stamp for each advertisement that is delivered to the end user's computer.

3. The system of claim 2, wherein the advertise module is further programmed to deliver the record to an advertiser and to accept payment from the advertiser.

4. The system of claim 1, wherein the render module is further programmed to deliver the advertising content such that the advertising content occupies a substantial portion of the end user's display.

5. The system of claim 1, wherein the period of time is at least two seconds.

6. The system of claim 1, wherein the monitor module is further programmed to monitor the end user's interaction with respect to the advertising content.

7. A method for facilitating an exchange between a buyer and a seller, the method comprising:
allowing a seller to create a sale posting for selling an item;
prompting the seller for upfront payment of a transaction fee;
if the seller makes the upfront payment of the transaction fee, displaying the sale posting in an online environment including contact information for the seller; and
if the seller does not pay the upfront payment of the transaction fee:
displaying the sale posting in the online environment without the contact information for the seller;
allowing a potential buyer to pay the transaction fee to receive the contact information of the seller, or to express interest in the item;
if the potential buyer pays the transaction fee, sending the contact information for the seller to the potential buyer, and sending contact information for the potential buyer to the seller;
if the potential buyer expresses interest in the item, notifying the seller of the potential buyer and allowing the buyer to pay the transaction fee; and
if the seller pays the transaction fee, sending the contact information for the potential buyer to the seller.

8. The method of claim 7, wherein notifying the seller of the potential buyer further comprises sending the seller an email or text message.

9. The method of claim 7, wherein allowing the seller to create the sale posting further comprises allowing the seller to create the sale posting for selling a textbook.

10. The method of claim 7, further comprising allowing the potential buyer to create a wanted posting for purchasing a desired item.

11. The method of claim 7, further comprising organizing a plurality of sale postings from a plurality of sellers according to a local area.

12. The method of claim 11, wherein organizing the plurality of sale postings from the plurality of sellers further comprises organizing the plurality of sale postings from the plurality of sellers according to campus locations.

13. The method of claim 7, further comprising allowing the potential buyer or the seller to pay the transaction fee using earned credits.

14. A method for facilitating a personal exchange of a used textbook on a campus of an educational institution, the method comprising:
providing a representative located on the campus to facilitate and advertise an online environment that allows students to sell used textbooks;
presenting online sale postings for the used textbooks;
providing to a potential student buyer contact information for a student seller of a used textbook; and
allowing the potential student buyer to meet with the student seller to review the used textbook prior to purchasing the used textbook.

15. The method of claim 14, further comprising organizing the sale postings according to local areas.

16. The method of claim 15, wherein organizing the sale postings further comprises organizing the sale postings according to campus areas.

17. The method of claim 16, wherein allowing the potential student buyer to meet with the student seller further comprises allowing the potential student buyer to meet with the student seller at one of the campus areas.

18. The method of claim 14, further comprising requiring payment of a transaction fee before providing the contact information for the student seller to the potential student buyer.

19. The method of claim 18, further comprising allowing the potential student seller to pay the transaction fee using earned credits.

20. The method of claim 14, further comprising presenting online sale postings for college examinations, college notes, entertainment items, or furniture.
